(19) United States
(12) Patent Application Publication
(10) Pub. No.: US 2023/0064769 A1
(43) Pub. Date: Mar. 2, 2023

(54) PRESSURE SENSOR

(71) Applicant: Peratech Holdco Limited, North Yorkshire (GB)

(72) Inventors: Xu FENG, Jiansu (CN); Sun Kun, Jiansu (CN); Wei Xin, Jiansu (CN)

(21) Appl. No.: 17/794,713

(22) PCT Filed: Jan. 21, 2021
(86) PCT No.: PCT/GB2021/000006

§ 371 Date: Jul. 22, 2022

(30) Foreign Application Priority Data
Jan. 22, 2020 (CN) 202020145290.X

(51) Int. Cl. G01L 1/20; G01L 9/00; G06F 3/041

(52) U.S. Cl. CPC G01L 1/205; G01L 9/0051; G06F 3/0414; G01L 2009/0069

(57) ABSTRACT

A pressure sensor comprises a substrate and a conductive layer disposed on the substrate and a spacer layer having a thickness larger than the thickness of the conductive layer. The pressure sensor also comprises an elastic membrane connected to the spacer layer, which overlays the conductive layer with the spacer layer providing a space therebetween and a sensing electrode layer arranged on a lower surface of the elastic membrane and spaced apart from the conductive layer. The sensing electrode layer forms at least two electrodes opposed and spaced apart from each other. The two electrodes are respectively connected to respective connectors and contact the conductive layer in response to an applied pressure on the elastic membrane. Each electrode transmits an output signal of resistance data to a processor through the respective connector.

### CROSS REFERENCE TO RELATED APPLICATIONS

This application claims priority from Chinese Utility Model number ZL 2020 2 0145290.X, filed on 22 Jan. 2020, the whole contents of which are incorporated herein by reference.

### BACKGROUND OF THE INVENTION

The present invention relates to a pressure sensor, an electronic device comprising a pressure sensor and a method of determining a location of an applied force on a pressure sensor.

Generally, in pressure sensor applications such as strain gauges or electrical contact type sensors, the deformation of a mechanical structure of an elastic object must maintain a strict linear relationship with the deformation of the strain gauge or film membrane of the sensor. This allows the strain gauge or film to reach a higher strain level which can improve the sensitivity of response and accurately measure the pressure change.

However, even if sensitivity is increased in these conventional applications, in order to identify an applied pressure in a plurality of regions of the pressure sensor, a plurality of sensing element must be provided, such that multiple signal lines also must be provided to transmit a sensing signal from each sensing element, resulting in complex wiring systems and a corresponding complex process.

The present application seeks to provide a pressure sensor and electronic device which aims to reduce wiring difficulties and process complexity.

### BRIEF SUMMARY OF THE INVENTION

According to a first aspect of the present invention, there is provided a pressure sensor, comprising: a substrate; a conductive layer disposed on said substrate, said conductive layer having a first thickness; a spacer layer having a second thickness which is larger than said first thickness; an elastic membrane connected to said spacer layer, said elastic membrane overlaying said conductive layer, said spacer layer providing a space between said elastic membrane and said conductive layer; a sensing electrode layer arranged on a lower surface of said elastic membrane and spaced apart from said conductive layer; said sensing electrode layer forms at least two electrodes opposed and spaced apart from each other, said at least two electrodes comprising a first electrode and a second electrode; wherein said first electrode and said second electrode are respectively connected to a first connector and a second connector; said first electrode and said second electrode are configured to contact said conductive layer in response to an applied pressure on said elastic membrane to achieve an electrical connection; and said first electrode is configured to transmit a first output signal of resistance data to a processor through said first connector and said second electrode provides a second output signal of resistance data to said processor through said second connector.

According to a second aspect of the present invention, there is provided a method of determining a location of an applied force on a pressure sensor, comprising the steps of: providing a pressure sensor comprising: a substrate; a conductive layer disposed on said substrate, said conductive layer having a first thickness; a spacer layer having a second thickness which is larger than said first thickness; an elastic membrane connected to said spacer layer, said elastic membrane overlaying said conductive layer, said spacer layer providing a space between said elastic membrane and said conductive layer; a sensing electrode layer arranged on a lower surface of said elastic membrane and spaced apart from said conductive layer; said sensing electrode layer forms at least two electrodes opposed and spaced apart from each other, said at least two electrodes comprising a first electrode and a second electrode; connecting said first electrode and said second electrode respectively to a first connector and a second connector; applying a pressure to said elastic membrane such that said first electrode and said second electrode contact said conductive layer to achieve an electrical connection; transmitting a first output signal of resistance data from said first electrode through said first connector to a processor; and transmitting a second output signal of resistance data from said second electrode through said second connector to said processor.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows a schematic cross-sectional diagram of a layer structure of a pressure sensor in accordance with the present invention;

FIG. 2 shows a schematic plan view of a first embodiment of the pressure sensor of the present invention;

FIG. 3 shows a schematic diagram of an arrangement of a pressure sensor in combination with a processor and signal processing circuit;

FIG. 4 shows a schematic plan view of a second embodiment of the pressure sensor of the present invention;

FIG. 5 shows a schematic plan view of a third embodiment of a pressure sensor of the present invention;

FIG. 6 shows a pressure sensor in accordance with the invention under the application of an applied pressure;

FIG. 7 shows a schematic structural diagram of an elastic membrane of a pressure sensor according to an embodiment of the application; and

FIG. 8 shows an electronic device incorporating a pressure sensor in accordance with the present invention.

### DETAILED DESCRIPTION OF EMBODIMENTS OF THE INVENTION

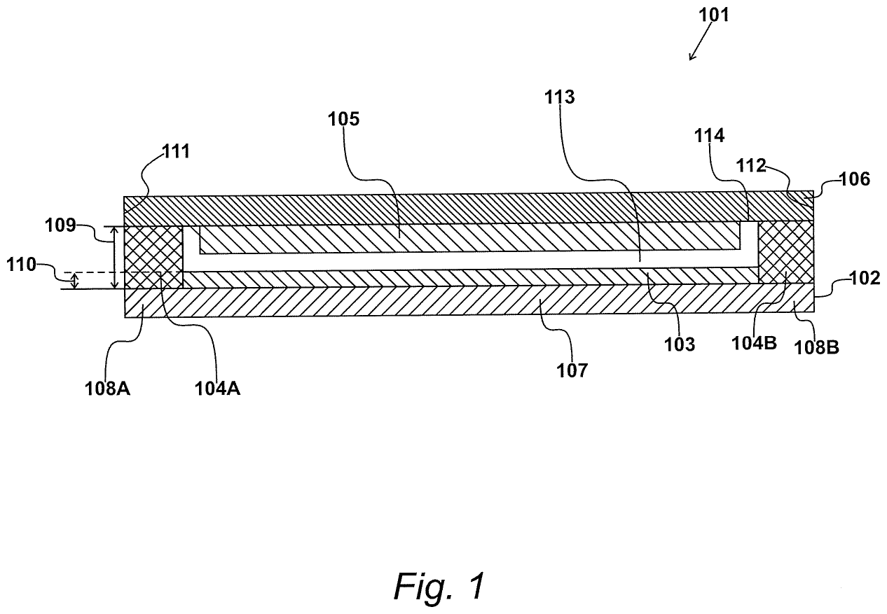

### FIG. 1

FIG. 1 is a schematic cross-sectional diagram of a layered structure of a pressure sensor in accordance with the present invention.

Pressure sensor 101 comprises a substrate 102, a conductive layer 103, a spacer layer 104, a sensing electrode layer 105 and an elastic membrane 106.

In the embodiment, conductive layer 103 is disposed in a first region 107 across substrate 102. Spacer layer 104 is disposed in two further regions 108 to either side of the first region and conductive layer 103, as shown. Spacer layer 104 has a thickness 109 which is greater than the thickness 110 of conductive layer 103.

In the embodiment, elastic membrane 106 is connected at a first end 111 to spacer layer 104A and connected at a second end 112 to spacer layer 104B thereby overlaying conductive layer 103 appropriately. Thus, spacer layer 104 ensures a space 113 is provided between elastic membrane 106 and conductive layer 103.

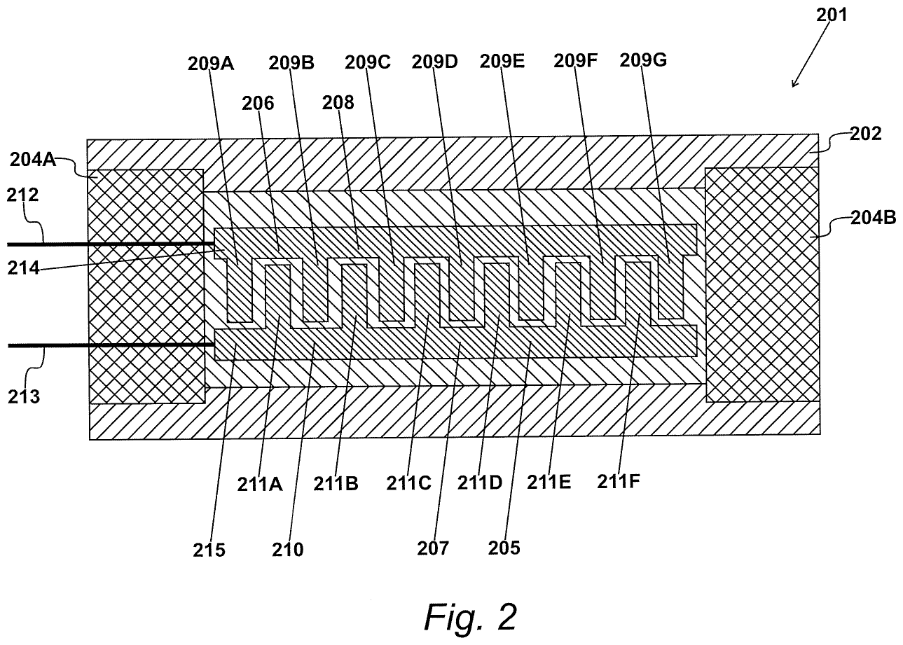

In the embodiment, sensing electrode layer 105 is disposed on a lower surface 114 of elastic membrane 106 and becomes electrically connected to conductive layer 103 on the application of an applied pressure. In the embodiment, sensing electrode layer 105 forms at least two electrodes, as will be described further with respect to FIG. 2.

Substrate 102 may comprise a flexible plastics material. However, in alternative embodiments, it is appreciated that substrate 102 can be any suitable substrate having suitable physical properties, such as a glass substrate.

In an embodiment, substrate 102, comprises a base layer and a carbon layer disposed on the base layer.

In the embodiment, conductive layer 103 comprises a metallic material and, in a specific embodiment, comprises a material of suitable conductivity formed by a metal deposition process. An example of a suitable material for the conductive layer is a material comprising silver or a material comprising copper to provide a suitable conductivity.

In an embodiment, spacer layer 104 comprises an adhesive. In a specific embodiment, spacer layer 104 comprises a colloid-based material.

### FIG. 2

FIG. 2 shows a plan view of an embodiment of a pressure sensor 201 in accordance with the invention. Pressure sensor 201, in cross-sectional view, may appear substantially similar to pressure sensor 101 in FIG. 1. FIG. 2 shows pressure sensor 201 comprising substrate 202, conductive layer 203 and spacer layer 204.

In the embodiment, as described in FIG. 1, a sensing electrode layer 205 is disposed on a lower surface of an elastic membrane and is connected to conductive layer 203. In the embodiment, sensing electrode layer 205 forms at least two electrodes.

In the embodiment, the at least two electrodes comprise a first electrode 206 and a second electrode 207 that are opposed and spaced apart. First electrode 206 and second electrode 207 are used to contact conductive layer 203 when a user applies a force or pressure to the elastic membrane of the pressure sensor. In this way, an electrical connection occurs and resistance data from first electrode 206 and second electrode 207 can be output to a processor.

In the embodiment, first electrode 206 comprises a first main electrode 208 and a plurality of first branch electrodes 209. Second electrode 207 comprises a second main electrode 210 and a plurality of second branch electrodes 211.

In the embodiment, first main electrode 208 and second main electrode 210 both extend along a first predetermined direction (in this illustrated example, horizontally). In an embodiment, the main electrodes may extend in a meandering or patterned manner, or extend along a straight line.

In the embodiment, one end of each first branch electrode, 209 is perpendicularly connected to the first main electrode 208, and one end of each second branch electrode 211 is perpendicularly connected to the second main electrode 210.

In the embodiment, first electrode 206 and second electrode 207 are formed using a photolithography process.

In the embodiment, first main electrode 208 and second main electrode 210 are spaced apart, and first main electrode 208, each first branch electrode 209, second main electrode 210, and each second branch electrode 211 are all connected to conductive layer 203. Conductive layer 203 is positioned directly opposite, that is, first main electrode 208, each first branch electrode 209, second main electrode 210, and each second branch electrode 211 on substrate 202 comprise a vertical projection from conductive layer 203 located within range of conductive layer 203.

In the embodiment, the plurality of first branch electrodes 209 are arranged at intervals on one side of first main electrode 208 which is closest to second main electrode 210. One end of each first branch electrode 209 is connected to first main electrode 208.

Similarly, the plurality of second branch electrodes 211 are arranged at intervals on one side of second main electrode 210 which is closest to first main electrode 208 and one end of each second branch electrode 211 is connected to second main electrode 210. The opposite end of each first branch electrode 209 extends into the gap between two adjacent second branch electrodes 211, and the opposite end of each second branch electrode 211 extends into the gap between two adjacent first branch electrodes 209.

In the embodiment, first main electrode 208 and second main electrode 210 are linear and parallel to each other. Specifically, first main electrode 208 and second main electrode 210 are both substantially rectangular and elongated.

In the embodiment, each first branch electrode 209 and each second branch electrode 211 comprise rectangular strips of material of substantially similar lengths and widths. In the embodiment, the plurality of first branch electrodes 209 and the plurality of second branch electrodes 211 are substantially parallel to each other.

Pressure sensor 201 further comprises a first connector 212 and a second connector 213, which, in the embodiment, comprise wiring for connection to a processor and signal processing circuit.

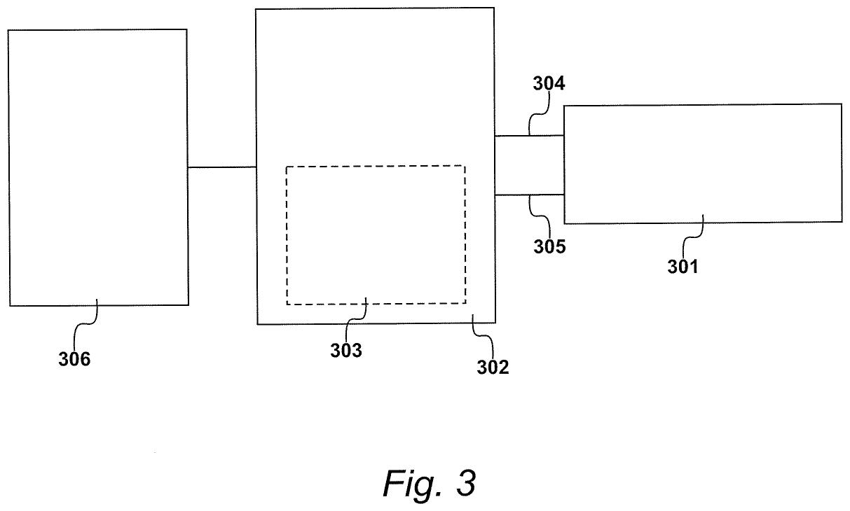

As shown, connector 212 is connected to one end 214 of first electrode 206. Similarly, connector 213 is connected to one end 215 of second electrode 207. Thus, a processor can be electrically connected to connectors 212 and 213 as described in FIG. 3.

### FIG. 3

FIG. 3 illustrates a schematic block diagram illustrating the connection of a pressure sensor 301 to a processor 302.

Pressure sensor 301 may be substantially similar to either pressure sensor 101 or 201 previously described, or any other pressure sensor described in accordance with the present application. Processor 302 comprises a signal processing circuit 303 which is configured to process a signal received from either connector 304 or connector 305. It is appreciated that, in the embodiment of FIG. 2, connectors 304 and 305 are analogous to connectors 212 and 213 and pressure sensor 301 is correspondingly analogous to pressure sensor 201.

Thus, in the embodiment, connector 304 and connector 305 are electrically connected to processor 302.

In the embodiment, signal processing circuit 303 is configured to determine the contact positions of a first electrode and a second electrode with a corresponding conductive layer of the appropriate pressure sensor according to resistance data received by means of a signal. Signal processing circuit 303 is then configured to calculate positional data of an applied pressure on the elastic membrane of pressure sensor 301. A further output may optionally be provided to an electronic device 306, as necessary.

In some embodiments, the signal processing circuit is not indispensable. In an alternative embodiment, pressure sensor 301 outputs resistance data directly to an external electronic device 306, and electronic device 306 calculates that the elastic membrane has been pressed based on the resistance data and location data provided though its own processing capacity.

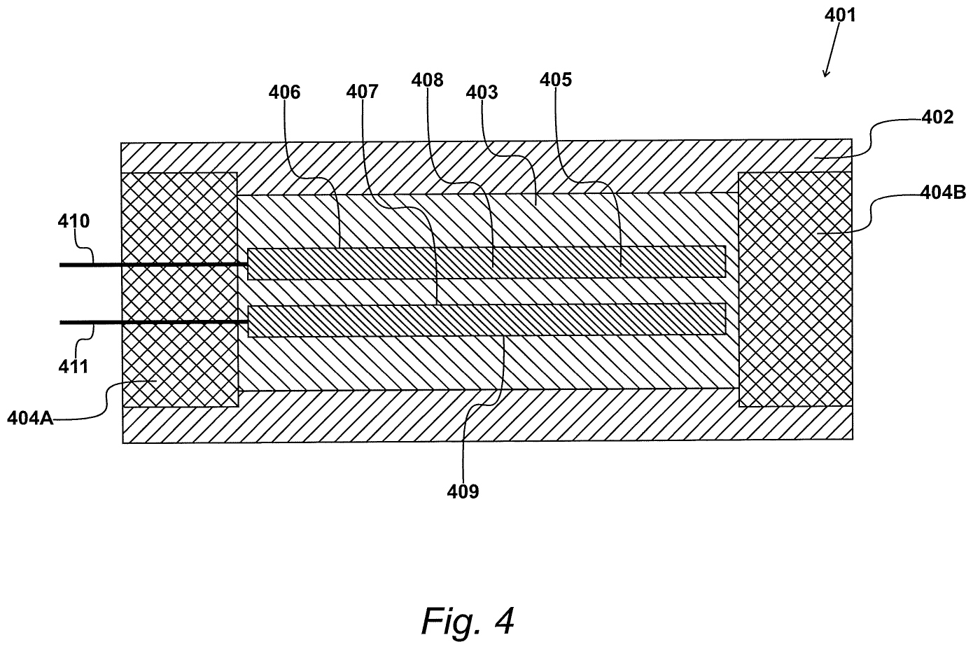

### FIG. 4

An alternative embodiment, as shown in FIG. 4, provides an alternative pressure sensor 401 in accordance with the invention. FIG. 4 shows a plan view of pressure sensor 401 which appears substantially similar to pressure sensor 101 of FIG. 1 in cross-sectional view.

FIG. 4 shows pressure sensor 401 comprising substrate 402, conductive layer 403, spacer layer 404 and sensing electrode layer 405 forming two electrodes.

In the embodiment of FIG. 4, first electrode 406 and second electrode 407 both extend along a substantially straight line. First electrode 406 comprises a first main electrode 408, and second electrode 407 comprises a second main electrode 409. In this way, pressure sensor 401 differs from pressure sensor 201 by not including branch electrodes in the manner of pressure sensor 201. In other respects, however, pressure sensor 401 may be considered substantially similar to pressure sensor 201.

Pressure sensor 401 further comprises a first connector 410 and a second connector 411, which, in the embodiment, comprise wiring for connection to a signal processing circuit, in a substantially similar manner to that of pressure sensor 201 as described with respect to FIG. 3.

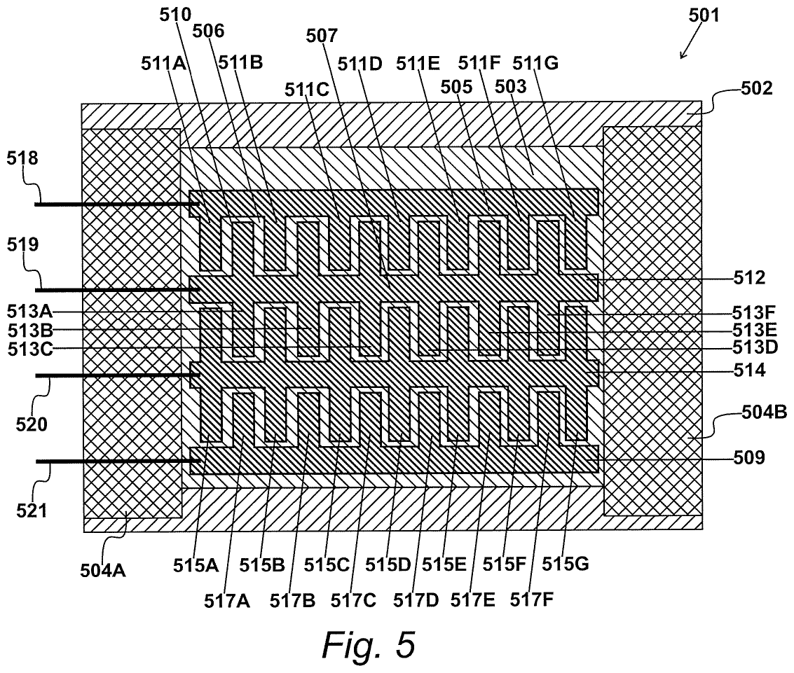

### FIG. 5

A still further embodiment of a pressure sensor in accordance with the present invention is shown in FIG. 5.

The still further embodiment shown in FIG. 5, provides a pressure sensor 501 in accordance with the invention. FIG. 5 shows a plan view of pressure sensor 501 which appears substantially similar to pressure sensor 101 of FIG. 1 in cross-sectional view. Pressure sensor 501 comprises substrate 502, conductive layer 503, spacer layer 504 and sensing electrode layer 505.

In the embodiment, sensing electrode layer 505 comprises a first electrode 506, a second electrode 507, a third electrode 508 and a fourth electrode 509. It is appreciated that, in accordance with the invention in respect of alternative embodiments, sensing electrode layer 505 can also comprise more than four electrodes or any other suitable number of electrodes depending on the requirements in question. The following example in relation to FIG. 5 covers an example embodiment having four electrodes, however.

In the embodiment, first electrode 506, second electrode 507, third electrode 508 and fourth electrode 509 extend along the direction of the X axis, with the direction perpendicular to the X axis and the direction in which the branch electrodes extend being the Y axis.

In the embodiment, first electrode 506 comprises a first main electrode 510 and a plurality of first branch electrodes 511. Second electrode 507 comprises a second main electrode 512 and a plurality of second branch electrodes 513. Third electrode 508 comprises a third main electrode 514 and a plurality of third branch electrodes 515. Similarly, fourth electrode 509 comprises a fourth main electrode 516 and a plurality of fourth branch electrodes 517.

As shown, first main electrode 510, second main electrode 512, third main electrode 514 and fourth main electrode 516 are uniformly spaced apart sequentially. In the embodiment, first main electrode 510, second main electrode 512, third main electrode 514 and fourth main electrode 516 are substantially rectangularly-shaped strips and are parallel to each other.

The plurality of first branch electrodes 511 are arranged at intervals on one side of first main electrode 510 closest to second main electrode 512. One end of each first branch electrode 511 is connected to first main electrode 510. The plurality of second branch electrodes 513 are evenly distributed on both sides of the second main electrode 512.

Similarly, the plurality of third branch electrodes 515 are evenly distributed on both sides of the third main electrode 514, and the plurality of fourth branch electrodes 517 are evenly distributed on one side of fourth main electrode 516 closest to third main electrode 514.

Additionally, in the embodiment, the plurality of second branch electrodes 513 located closest to first main electrode 510 are distributed evenly alongside first branch electrodes 511. Similarly, the plurality of second branch electrodes 513 located closest to third main electrode 514 are distributed evenly alongside the corresponding third branch electrodes 515, and the plurality of third branch electrodes 515 located closest to fourth main electrode 516 are distributed evenly alongside the plurality of fourth branch electrodes 517.

In the embodiment, in addition to first and second connectors 518 and 519, a third connector 520 and fourth connector 521 are also included in pressure sensor 501. First and second connectors 518 and 519 are connected in a substantially similar manner to connectors 212 and 213 of FIG. 2 as described previously.

In the embodiment, one end of the third connector 520 is connected to third electrode 508 with the opposite end of third connector 520 being connected to a processor and signal processing circuit in a substantially similar manner to the first and second connectors as described with respect to FIG. 3. Similarly, one end of the fourth connector 521 is connected to fourth electrode 509 while the opposite end of fourth connector 521 is connected to a processor and corresponding signal processing circuit.

In the embodiment, the signal processing circuit is configured to detect resistance data between two adjacent electrodes, thereby not only calculating the coordinates in the X axis direction of an applied pressure position, but also detecting the coordinates in the Y axis direction of an applied pressure position.

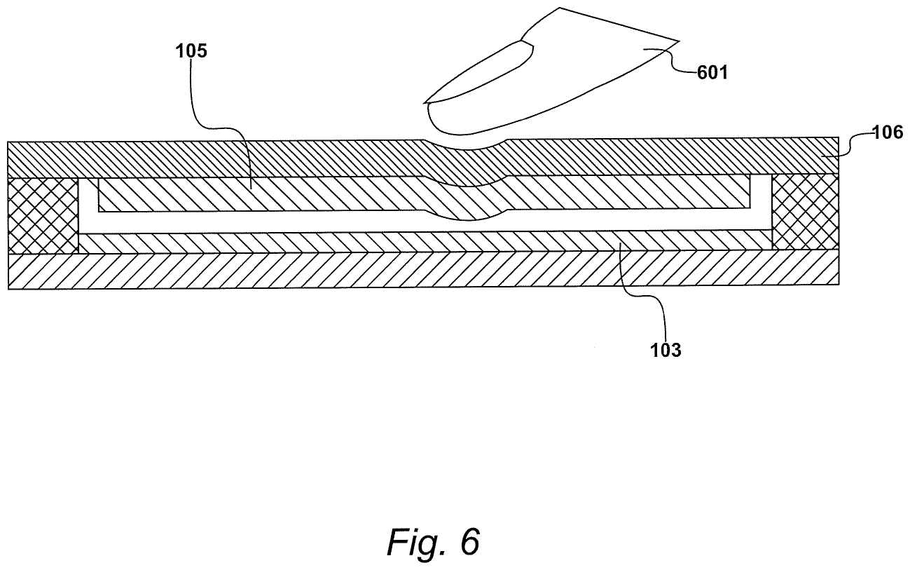

### FIG. 6

In operation, a user can apply a pressure to any of the pressure sensors previously described to achieve an output of resistance data derived from an applied pressure to the pressure sensor in question. The output of resistance data can then be provided to the signal processing circuit of a processor as illustrated and described previously in FIG. 3. FIG. 6 illustrates an application of force applied to a pressure sensor in accordance with the invention, which may be substantially similar to any of the previous pressure sensors described herein. For simplicity, numerals in the embodiment of FIG. 6, are substantially similar to those described in relation to pressure sensor 101 of FIG. 1. It is appreciated, however, that the elements of pressure sensor 101 may be substituted in operation for any of the alternative embodiments of pressure sensor described herein.

As shown, when a user 601, for example applies a pressure to elastic membrane 106 by means of a finger press, the corresponding area of sensing electrode layer 105 moves towards conductive layer 103. Thus, the two electrodes on sensing electrode layer 105 which are positioned in the location of the applied pressure are connected by means of conductive layer 103.

In this way, a pre-set range of resistance can be detected at a specific location. In addition, as the other electrodes are non-conductive given the lack of applied pressure, the resistance generated is infinite, which enables determination of the Y-axis co-ordinate of the location where applied pressure occurs.

The resistance data detected by the signal processing circuit 303 of processor 302 will differ depending on the location of the pressure applied due to the difference in the positions of the two connected electrodes. Thus, the X-axis coordinates of the position where pressure is applied can be calculated by detecting the resistance values of the two connected electrodes.

It is appreciated that the greater the number of electrodes formed by the sensing electrode layer, the greater the accuracy of the coordinates in the vertical direction.

Further, in order to avoid the application of a pressure directly on the main electrode, it is preferable to ensure that the width of each main electrode is relatively narrow and specifically smaller than the length of any branch electrode.

Thus, the pressure sensor described herein provides first and second electrodes for contacting a conductive layer when a force is externally applied to the elastic membrane of the pressure sensor to achieve electrical connection. Resistance date is output relating to the first electrode and the second electrode to the signal processing circuit which is then utilized for calculating the position of applied pressure on the elastic membrane. In this way, location detection of applied pressure is realized by the utilization of two electrodes only, which reduces the complexity of processing and simplifies the connections and wiring.

By providing a first electrode, second electrode, third electrode and fourth electrode, as per the embodiment of FIG. 5, the location of applied pressure in the extending direction (X direction) of the electrode can be detected, while simultaneously, the location of applied pressure in the direction of electrode arrangement (perpendicular to the extending direction—Y direction) can also be detected. This conveniently increases the pressure detection range while improving the accuracy of the detection location.

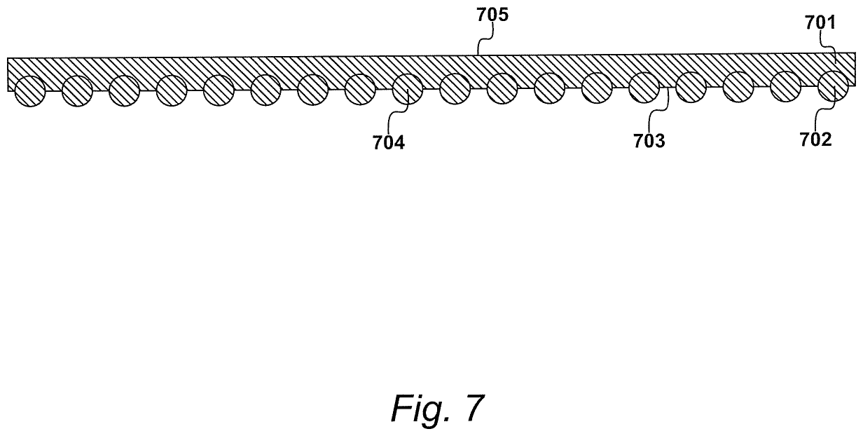

### FIG. 7

FIG. 7 illustrates an example elastic membrane 701 utilized in accordance with the present invention in relation to any one of the pressure sensors described herein. In some embodiments, as shown in FIG. 7, elastic membrane 701 is provided with an irregular surface 702 on its lower surface 703. Irregular surface 702 provides a concentration of the pressure applied (such as the finger press of FIG. 6) to elastic membrane 701, thereby ensuring that the sensitivity of the detection of applied pressure can be improved.

In the embodiment, irregular surface 702 comprises a plurality of protuberances or particles 704 arranged on lower surface 703 of elastic membrane 701.

It is appreciated that, in alterative embodiments, irregular surface 702 is disposed on an upper surface 705 of elastic membrane 701.

In further embodiments, an irregular surface may be alternatively provided to an upper surface of substrate 102. In this embodiment, the irregular surface on the substrate again comprises a plurality of protuberances or particles arranged on the upper surface of the substrate.

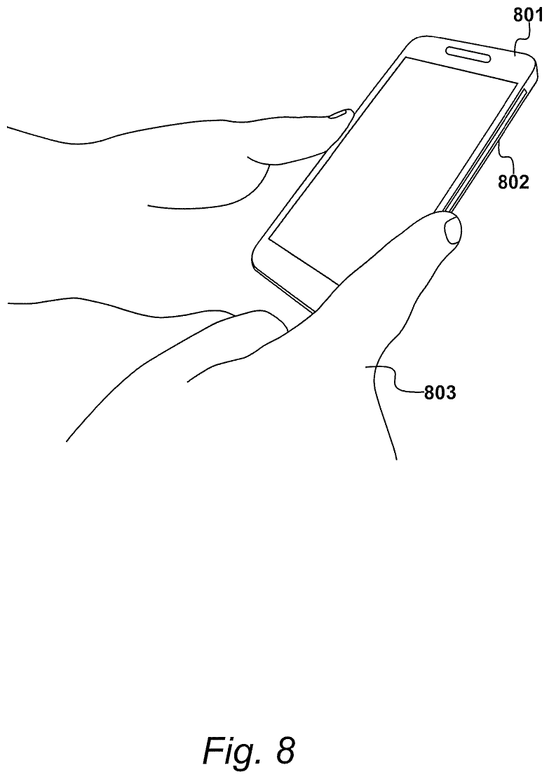

### FIG. 8

Any one of the embodiments of the pressure sensor described herein may be suitably incorporated into an electronic device. FIG. 8 illustrates electronic device 801, which, in this illustrated embodiment, comprises a mobile telephone.

It is appreciated that in further embodiments, the electronic device may be any other suitable electronic device which requires the use of a pressure sensor. For example, in alternative embodiments, electronic device comprises a detection device, a smart flashlight or other electronic equipment.

In the embodiment, electronic device 801 includes a pressure sensor which is incorporated as part of an input device 802 positioned on a side edge of electronic device 801. On receipt of an applied pressure by means of a finger press of user 803, a signal can be provided to a signal processing circuit incorporated within the device as described previously.

1. A pressure sensor, comprising:
a substrate;
a conductive layer disposed on said substrate, said conductive layer having a first thickness;
a spacer layer having a second thickness which is larger than said first thickness;
an elastic membrane connected to said spacer layer, said elastic membrane overlaying said conductive layer, said spacer layer providing a space between said elastic membrane and said conductive layer; and
a sensing electrode layer arranged on a lower surface of said elastic membrane and spaced apart from said conductive layer;
said sensing electrode layer forms at least two electrodes opposed and spaced apart from each other, said at least two electrodes comprising a first electrode and a second electrode; wherein:
said first electrode and said second electrode are respectively connected to a first connector and a second connector;
said first electrode and said second electrode are configured to contact said conductive layer in response to an applied pressure on said elastic membrane to achieve an electrical connection; and
said first electrode is configured to transmit a first output signal of resistance data to a processor through said first connector and said second electrode provides a second output signal of resistance data to said processor through said second connector.

2. The pressure sensor of claim 1, wherein said substrate comprises a first region and two further regions located at either side of said first region; and said conductive layer is disposed in said first region, and said spacer layer is disposed on each said two further regions.

3. The pressure sensor of claim 1, wherein said processor further comprises a signal processing circuit:
said signal processing circuit being connected to said first connector and said second connector, and configured to:
obtain said resistance data;
calculate a first contact position of said first electrode with said conductive layer from said resistance data;
calculate a second contact position of said second electrode with said conductive layer from said resistance data; and
determine a location of said applied pressure on said elastic membrane.

4. The pressure sensor of claim 1, wherein said first electrode comprises a first main electrode, and said second electrode comprises a second main electrode;
said first main electrode and the second main electrode each extend along a first predetermined direction; and
said first main electrode and said second main electrode are spaced apart from each other and each are positioned directly opposite to said conductive layer in a second predetermined direction.

5. The pressure sensor of claim 4, wherein said first main electrode and said second main electrode each comprise substantially rectangular strips and are located parallel to each other.

6. The pressure sensor of claim 4, wherein said first electrode further comprises a plurality of first branch electrodes, and said second electrode further comprises a plurality of second branch electrodes.

7. The pressure sensor of claim 6, wherein said plurality of first branch electrodes are arranged at intervals on a side of said first main electrode closest to said second main electrode, and one end of said plurality of first branch electrodes is connected to said first main electrode.

8. The pressure sensor of claim 6, wherein said plurality of second branch electrodes are arranged at intervals on a side of said second main electrode closest to said first main electrode, and one end of said plurality of second branch electrodes is connected to said second main electrode.

9. The pressure sensor of claim 8, wherein an opposite end of each said plurality of first branch electrodes extends into a gap between two adjacent second branch electrodes, and an opposite end of each said plurality of second branch electrodes extends into a gap between two adjacent first branch electrodes.

10. The pressure sensor of claim 6, wherein said plurality of first branch electrodes and said plurality of second branch electrodes are parallel to each other, and said plurality of first branch electrodes are perpendicularly connected to said first main electrode, and said plurality of said second branch electrodes are vertically connected to said second main electrode.

11. The pressure sensor of claim 1, wherein said at least two electrodes further comprise a third electrode and a fourth electrode.

12. The pressure sensor of claim 11, wherein said first electrode comprises a first main electrode and a plurality of first branch electrodes;
said second electrode comprises a second main electrode and a plurality of second branch electrodes;
said third electrode comprises a third main electrode and a plurality of third branch electrodes; and
said fourth electrode comprises a fourth main electrode and a plurality of fourth branch electrodes.

13. The pressure sensor of claim 12, wherein said first main electrode, said second main electrode, said third main electrode, and said fourth main electrode are arranged in parallel and uniformly spaced apart sequentially.

14. The pressure sensor of claim 13, wherein:
said plurality of first branch electrodes are evenly distributed on a first side of said first main electrode and one end of each of the first branch electrodes is connected to the first main electrode;
said plurality of second branch electrodes are evenly distributed on both sides of said second main electrode;
said plurality of third branch electrodes are evenly distributed on both sides of said third main electrode; and
said plurality of fourth branch electrodes are evenly distributed on a second side of said fourth main electrode closest to said third main electrode.

15. The pressure sensor of claim 14, wherein:
said plurality of second branch electrodes located closest to said first main electrode are distributed evenly alongside said plurality of first branch electrodes;
said plurality of second branch electrodes located closest to said third main electrode are distributed evenly alongside said plurality of third branch electrodes located closest to said second main electrode; and
said plurality of third branch electrodes located closest to said fourth main electrode are distributed evenly alongside said plurality of fourth branch electrodes.

16. (canceled)

17. The pressure sensor of claim 1, wherein a lower surface of said elastic membrane is provided with an irregular surface.

18. The pressure sensor of claim 17, wherein said irregular surface comprises a plurality of protuberances or particles arranged on said lower surface of said elastic membrane.

19. An electronic device comprising the pressure sensor of claim 1, wherein said electronic device comprises one of the following:
a mobile telephone, a smart flashlight; a detection device.

20. (canceled)

21. A method of determining a location of an applied force on a pressure sensor, comprising the steps of:
providing a pressure sensor comprising: a substrate; a conductive layer disposed on said substrate, said conductive layer having a first thickness; a spacer layer having a second thickness which is larger than said first thickness; an elastic membrane connected to said spacer layer, said elastic membrane overlaying said conductive layer, said spacer layer providing a space between said elastic membrane and said conductive layer; and a sensing electrode layer arranged on a lower surface of said elastic membrane and spaced apart from said conductive layer; said sensing electrode layer forms at least two electrodes opposed and spaced apart from each other, said at least two electrodes comprising a first electrode and a second electrode;
connecting said first electrode and said second electrode respectively to a first connector and a second connector;
applying a pressure to said elastic membrane such that said first electrode and said second electrode contact said conductive layer to achieve an electrical connection;
transmitting a first output signal of resistance data from said first electrode through said first connector to a processor; and
transmitting a second output signal of resistance data from said second electrode through said second connector to said processor.

22. The method of claim 21, wherein said processor further comprises a signal processing circuit connected to said first connector and said second connector, said method further comprising the steps of:
calculating a first contact position of said first electrode with said conductive layer from said resistance data;
calculating a second contact position of said second electrode with said conductive layer from said resistance data; and
determining a location of said applied force on said elastic membrane.
